(19) United States
(12) Patent Application Publication
(10) Pub. No.: US 2025/0242293 A1
(43) Pub. Date: Jul. 31, 2025

(54) DYNAMIC ADSORPTION AND DESORPTION SYSTEM

(71) Applicant: Mosaic Materials, Inc., Alameda, CA (US)

(72) Inventors: Dustin Kraft, Houston, TX (US); Steven Craig Russell, The Woodlands, TX (US); Taylor Broussard, Houston, TX (US); Tiffany Burgess, Magnolia, TX (US)

(21) Appl. No.: 18/428,129

(22) Filed: Jan. 31, 2024

(51) Int. Cl. B01D 53/06

(52) U.S. Cl. CPC B01D 53/06; B01D 2257/504; B01D 2259/40088; B01D 2259/4067

(57) ABSTRACT

A system includes a first sorbent structure and a second sorbent structure, each of the first structure and the second structure including sorbent, a linkage configured to couple the first sorbent structure to the second sorbent structure, a desorption chamber having a desorption chamber door having an open position and a closed position. When the first sorbent structure or the second sorbent structure is within the desorption chamber and the desorption chamber door moves from the open position to the closed position, the first sorbent structure is decoupled from the second sorbent structure.

### BACKGROUND

Various manufacturing and chemical systems include the use of sorbents to remove gas(es), vapor(s), or a mixture thereof from a fluid via adsorption. For example, adsorption systems such as carbon capture systems may capture carbon dioxide via adsorption with sorbent(s). The sorbents may then be fed to a desorption system to remove the gas(es), vapor(s), or the mixture thereof from the sorbent. Improvement(s) in the adsorption and desorption systems may be desirable.

### SUMMARY

An embodiment of a system including a first sorbent structure and a second sorbent structure, each of the first structure and the second structure comprising sorbent, a linkage configured to couple the first sorbent structure to the second sorbent structure, a desorption chamber comprising a desorption chamber door having an open position and a closed position, wherein, when the first sorbent structure or the second sorbent structure is within the desorption chamber and the desorption chamber door moves from the open position to the closed position, the first sorbent structure is decoupled from the second sorbent structure

An embodiment of a system including sorbent structures comprising sorbent, linkages disposed between the sorbent structures configured to couple the sorbent structures together, a track configured to move the sorbent structures between adsorption stations in which the sorbent in the sorbent structures adsorbs gas(es), vapor(s), or a mixture thereof from a gas stream, and at least one desorption station in which desorption is performed on the sorbent in the sorbent structures, and a desorption chamber disposed at the desorption station comprising a desorption chamber door having an open position and a closed position, wherein, when a first sorbent structure of the sorbent structures is within the desorption chamber and the desorption chamber door moves from the open position to the closed position, the first sorbent structure is decoupled from a second sorbent structure of the sorbent structures that is adjacent to the first sorbent structure.

An embodiment of a method for desorption of a first sorbent structure coupled to a second sorbent structure via a linkage including moving a first sorbent structure into a desorption chamber with a desorption chamber door in an open position, moving the desorption chamber door to a closed position such that the first sorbent structure is decoupled from the second sorbent structure, performing desorption of sorbent of the first sorbent structure, moving the desorption chamber door to the open position such that the first sorbent structure is recoupled to the second sorbent structure, and simultaneously moving the first sorbent structure out of the desorption chamber and moving the second sorbent structure into the desorption chamber.

### BRIEF DESCRIPTION OF THE DRAWINGS

The following descriptions should not be considered limiting in any way. With reference to the accompanying drawings, like elements are numbered alike:

FIG. 1 is schematic diagram showing a dynamic adsorption and desorption system according to one or more embodiments;

FIG. 2 is schematic diagram showing a dynamic adsorption and desorption system according to one or more embodiments;

FIGS. 3A-3F are schematic diagrams showing a dynamic adsorption and desorption system according to one or more embodiments;

FIG. 4 is schematic diagram showing a portion of a dynamic adsorption and desorption system according to one or more embodiments;

FIG. 5 is a perspective view showing a portion of a dynamic adsorption and desorption system according to one or more embodiments;

FIG. 6 is a perspective view showing a desorption chamber according to one or more embodiments;

FIG. 7 shows a linkage according to one or more embodiments;

FIGS. 8A-8B are side cross-sectional views showing a portion of a dynamic adsorption and desorption system according to one or more embodiments;

FIG. 9 shows a linkage according to one or more embodiments

FIGS. 10A-10B are side cross-sectional views showing a portion of a dynamic adsorption and desorption system according to one or more embodiments.

### DETAILED DESCRIPTION

A detailed description of one or more embodiments of the disclosed apparatus and method are presented herein by way of exemplification and not limitation with reference to the Figures.

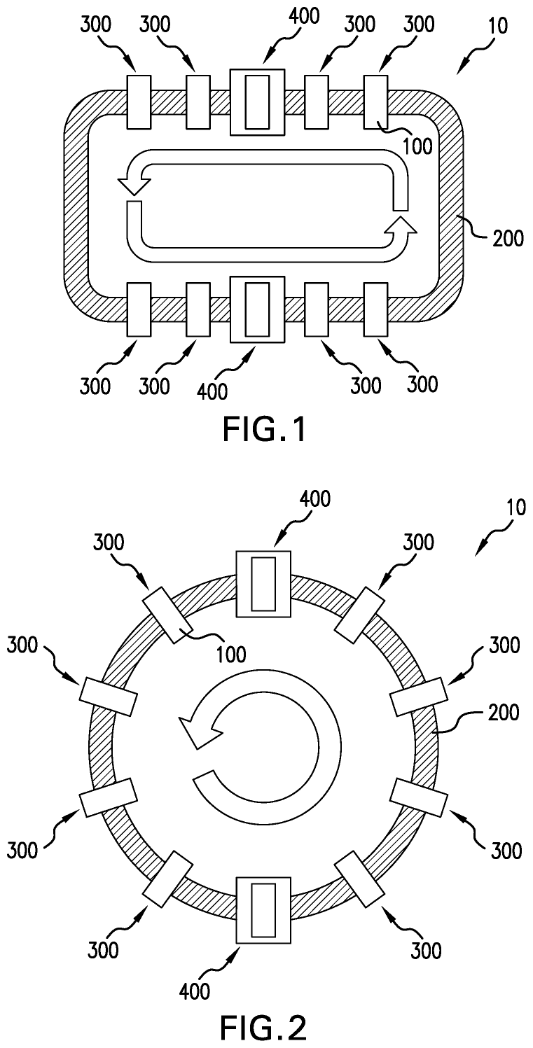

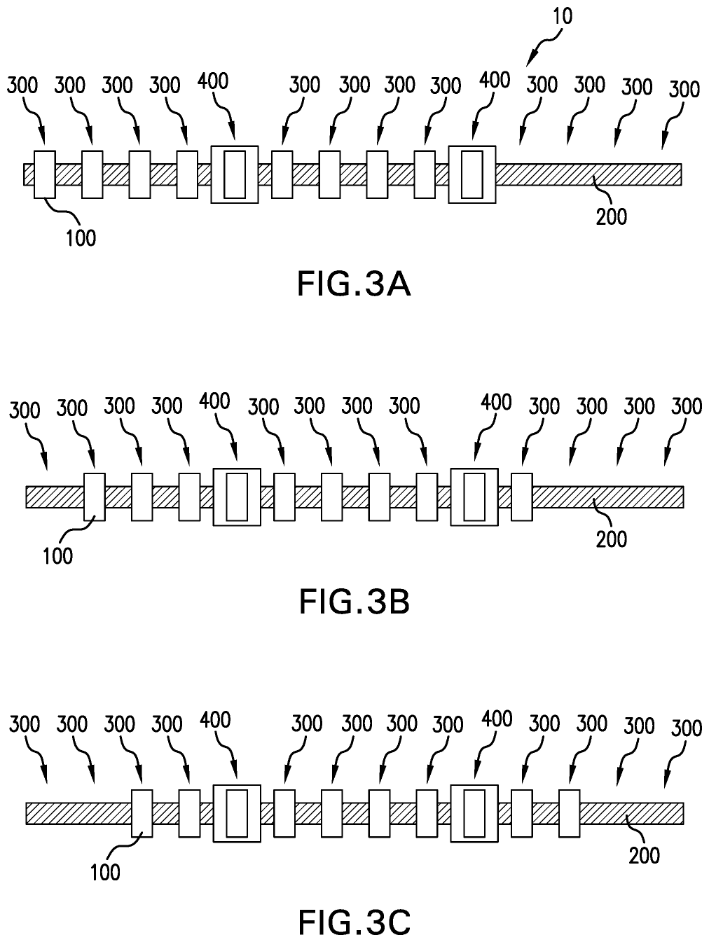

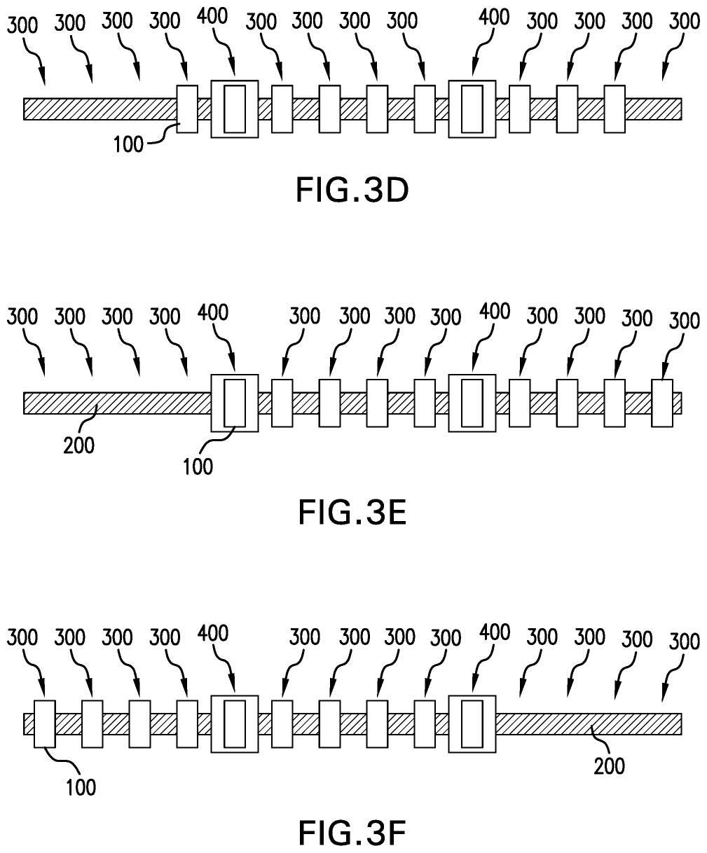

FIGS. 1, 2, and 3A-3F show embodiments of a dynamic adsorption and desorption system 10. As a non-limiting example, the dynamic adsorption and desorption system 10 may be part of a carbon capture system. As a non-limiting example, the dynamic adsorption and desorption system 10 may be part of a direct carbon capture system. The dynamic adsorption and desorption system 10 includes a plurality of sorbent carts 100. As a non-limiting example, the dynamic adsorption and desorption system 10 includes ten sorbent carts 100. The dynamic adsorption and desorption system 10 further includes a track 200 with a plurality of adsorption stations 300 and a plurality of desorption stations 400. The track 200 may take different shapes. In one exemplary embodiment, the track 200 may be rectangular with rounded corners as shown in FIG. 1. In another exemplary embodiment, the track 200 may be an oval or circular as shown in FIG. 2. In another exemplary embodiment, the track 200 may be linear as shown in FIGS. 3A-3F. The sorbent carts 100 are examples of sorbent structures. The sorbent carts 200 may be integral structures and/or assemblies. As non-limiting examples, the sorbent carts may be contactor assemblies, sorbent beds, and/or sorbent filters.

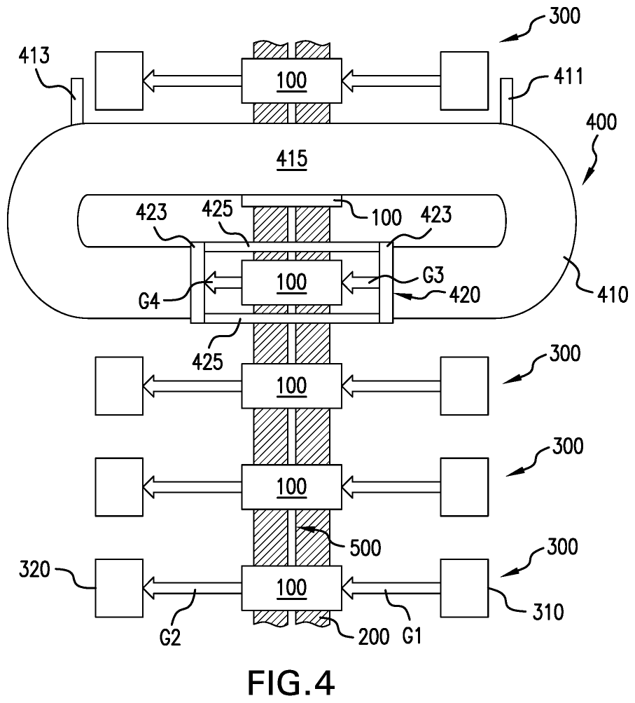

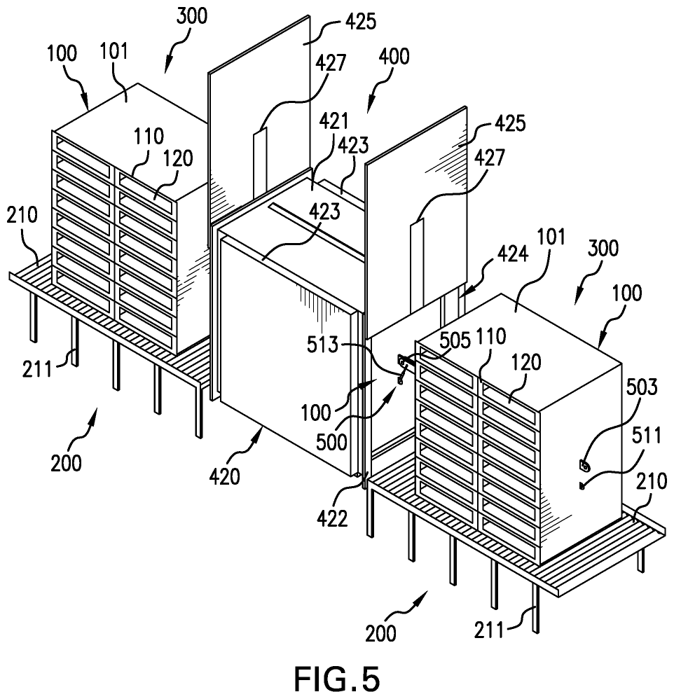

Adsorption may be performed at the adsorption stations 300 and desorption may be performed at the desorption stations 400. That is, at the adsorption stations 300, sorbent 120 in the sorbent carts 100 (see FIG. 5) adsorbs gas(es), vapor(s), or a mixture thereof from an input gas, and at the desorption stations 400, the gas(es), the vapor(s), or the mixture thereof adsorbed at the desorption stations 300 is desorbed from the sorbent 120 in the sorbent carts 100. For example, if the dynamic adsorption and desorption system 10 is part of a carbon capture system, at the adsorption stations 300, the sorbent 120 in the sorbent carts 100 adsorbs carbon dioxide from the input gas, and at the desorption stations 400, the carbon dioxide is desorbed from the sorbent 120 in the sorbent carts 100. In the non-limiting carbon capture example, the input gas may be atmospheric gas or flue gas from a manufacturing system or a chemical system. However, the input gas may be any gas that includes gas(es), vapor(s), or a mixture thereof that there is a benefit to removing from the input gas. The adsorption and desorption structures and processes will be described in more detail below with respect to FIGS. 4-10. Desorption may be performed by heating the sorbent 120 by convection, conduction, induction, and/or electromagnetic energy (e.g., microwave energy) and may include a vacuuming step

In the embodiments shown in FIGS. 1 and 2, the tracks 200 form a loop. After adsorption is performed at the adsorption stations 300 and desorption is performed at the desorption stations 400 for a period of time, the sorbent carts 100 on the track 200 may rotate in a direction indicated by the arrows so that each of the sorbent carts 100 moves to the next station, which may be an adsorption station 300 where adsorption is performed for the period of time or a desorption station 400 where desorption is performed for the period of time. Alternatively, the track 200 itself may rotate to the next station. This process is repeated as the sorbent carts 100 are cycled through the dynamic adsorption and desorption system 10. Thus, the sorbent carts 100 of the dynamic adsorption and desorption system 10 may share the same adsorption and desorption structures, and as a continuous cycle, the dynamic adsorption and desorption system 10 may reduce or eliminate the need to remove the sorbent carts 100 from the dynamic adsorption and desorption system 10 during normal operation. While FIGS. 1 and 2 show the sorbent carts 100 moving on the track 200 in a counter-clockwise direction, the present disclosure is not limited thereto, and the sorbent carts 100 may move on the track 200 in a clockwise direction or may alternate between clockwise and counter-clockwise directions.

In the embodiments shown in FIGS. 3A-3F, the track 200 is not a loop. Thus, after adsorption is performed at the adsorption stations 300 and desorption is performed at the desorption stations 400 for a period of time in the position shown in FIG. 3A, the sorbent carts 100 on the track 200 may move to the position shown in FIG. 3B so that each of the sorbent carts 100 moves to the next station, which may be an adsorption station 300 where adsorption is performed for the period of time or a desorption station 400 where desorption is performed for the period of time. Alternatively, the track 200 itself may rotate to the next station. This process is repeated as the sorbent carts 100 are moved through the dynamic adsorption and desorption system 10 as shown in FIGS. 3C, 3D, and 3E. At the position shown in FIG. 3E, the last sorbent cart 100 has reached the last adsorption station 300. Thereafter, the sorbent carts 100 are moved on the track 200 in the opposite direction to the initial position shown in FIG. 3A and the process is repeated. Thus, the sorbent carts 100 of the dynamic adsorption and desorption system 10 may share the same adsorption and desorption structures, and as a continuous cycle, the dynamic adsorption and desorption system 10 may reduce eliminate the need to remove the sorbent carts 100 from the dynamic adsorption and desorption system 10 during normal operation. While FIGS. 3A-3F show the track 200 being linear, the present disclosure is not limited thereto, and the track 200 may be curved.

The period of time spent at each position is not limited to any specific period. According to one or more embodiments, the period of time may be in a range having a lower limit of 5 minutes, 10 minutes, 15 minutes, 20 minutes or 25 minutes, and upper an upper limit of an hour, 55 minutes, 50 minutes 45 minutes, 40 minutes, or 35 minutes. The period of time may be, for example, 30 minutes.

While FIGS. 1-3F show the dynamic adsorption and desorption system 10 including eight adsorption stations 300 and two desorption stations 400 such that each sorbent cart 100 goes through four adsorption stations 300 prior to going through a desorption station 400, the present disclosure is not limited thereto. The dynamic adsorption and desorption system 10 may have any number of desorption stations 400 and adsorption stations 300, including a single adsorption station 300 and/or a single desorption station 400 and/or any plurality of adsorption stations 300 and any plurality of desorption stations 400. Additionally, the number of adsorption stations 300 that the sorbent cart 100 may go through prior to going through the desorption station 400 may also vary, from one to any plurality. As FIGS. 1-3F are schematic views, distances between the sorbent carts 100 shown are not limiting in any way. The dynamic adsorption and desorption system 10 may include additional process stations (e.g., inert gas purge, cooling, secondary desorption station, etc.).

While FIGS. 1-3F show adsorption stations 300 between desorption stations 400, this is not limiting. For example, a plurality of desorption stations 400 may be disposed adjacent to each other. In such a case, the desorption stations 400 may share desorption equipment.

A portion of dynamic adsorption and desorption system 10 according to one or more embodiments is shown in FIGS. 4 and 5. Each of the sorbent carts 100 may include a sorbent cart frame 101 that hold sorbent modules 110 containing sorbent 120. The sorbent 120, may be, for example, metal-organic frameworks, Zeolites, amine-impregnated porous materials, amine-functionalized porous materials, or a combination of one or more of the above. The sorbent 120 may be another sorbent known in the art or a combination of sorbents including those known in the art.

Each of the adsorption stations 300 may include a gas source 310 upstream of the sorbent cart 100 and a gas destination 320 downstream of the sorbent cart 100. The sorbent carts 100 may receive a first adsorption gas stream G1 from the gas source 310. The gas source 310 may be, for example, atmospheric such that the sorbent cart 100 may be part of a direct air capture system that receives atmospheric gas. The gas source 310 may be, for example, a manufacturing system, a chemical system, or a refinery system, and sorbent cart 100 may receive flue gas or other types of gas produced in the manufacturing system, the chemical system, or the refinery system. The gas from the gas source 310 may pass through the sorbent cart 100 and the sorbent 120 therein such that gas(es), vapor(s), or a mixture thereof may be adsorbed by the sorbent 120 in the sorbent cart 100. The first adsorption gas stream G1 passes through the sorbent cart 100 and has the gas(es), the vapor(s), or the mixture thereof adsorbed therefrom by the sorbent 120 in the sorbent cart 100 and exits the sorbent cart 100 as a second adsorption stream G2 that is fed to the gas destination 320. The gas destination 320 may be, for example, a tank or the atmosphere.

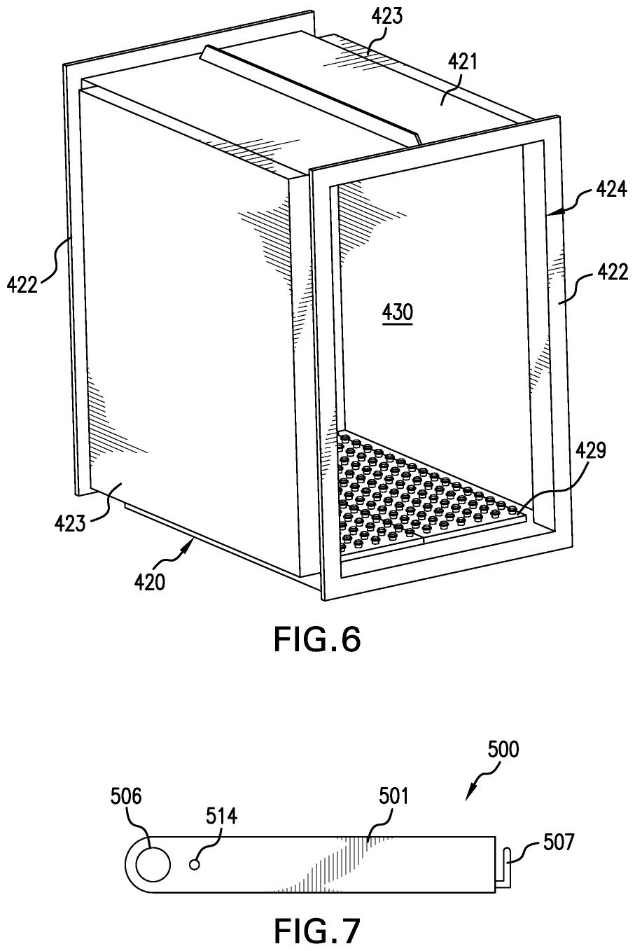

Each of the desorption stations 400 may include a desorption chamber 420, a non-limiting example of which is shown in FIG. 6. While the desorption chamber 420 is shown as a rectangular structure, the desorption chamber 420 is not limited thereto, and could take any appropriate shape, e.g., a cylindrical structure. The desorption chamber 420 may include a desorption chamber frame 421 that includes openings 424 on two sides. The desorption chamber 420 may also include dampers 423 on two sides. Alternatively, the desorption chamber 420 may be formed without the dampers 423, and instead the sides with the dampers 423 shown in FIG. 6 may be open. The desorption chamber 420 may further include flanges 422 surrounding the openings 424. The flanges 422 may include sealing elements formed thereon. The desorption chamber 420 includes a low friction floor 429. The low friction floor 429 may include a rolling ball transfer pad, parallel rollers, a low friction coating, a rail track, and/or any other low friction surface or structure known in the art. As shown in FIGS. 4 and 5, the desorption chamber 420 further includes movable desorption chamber doors 425 that, when closed, covers the openings 424. The desorption chamber doors 425 may create an airtight seal against the flanges 422. The desorption chamber doors 425 may include wear pads 427 disposed thereon. Alternatively, the wear pads 427 may be disposed only on one side of the desorption chamber doors 425, or the desorption chamber doors 425 may not include any wear pads 427. The desorption chamber frame 421 and the desorption chamber doors 425 may define a desorption chamber interior 430 therein. The desorption chamber doors 425 may close the openings 424 to isolate the desorption process.

Each of the desorption stations 400 may include a desorption conduit 410 which may form a flowpath 415 therein. As the desorption chamber doors 425 may create an airtight seal against the flanges 422 of the desorption chamber 420 when closed, the desorption conduit 410 and the desorption chamber 420 may form a closed flowpath. The desorption conduit 410 may be coupled to a flow inlet 411 and a flow outlet 413.

According to one or more embodiments, the desorption station 400 may perform desorption by heating the sorbent 120 in the sorbent carts 100. As non-limiting examples, the sorbent 120 may be heated via a heated flow of gas, heated via directly heating the sorbent, indirectly heating through conduction, heating with electromagnetic energy, or a combination thereof. An additional process step may include vacuuming to promote additional desorption beyond thermal processing.

In case of the heated flow of gas, the heated gas may enter the desorption conduit 410 via the flow inlet 411, or gas may enter the desorption conduit 410 via the flow inlet 411 and heated by a heater (not shown) on, within, and/or coupled to the desorption conduit 410 and may pass through the damper 423 into the desorption chamber 420 as a first desorption gas stream G3. A blower (not shown) may be disposed in or coupled to the desorption conduit 410 to generate flow of the gas through the desorption conduit 410. The first desorption gas stream G3 passes through the sorbent cart 100 such that the gas(es), the vapor(s), or the mixture thereof in the sorbent 120 in the sorbent cart 100 may be desorbed by the desorption gas stream G3 and exit the sorbent cart 100 as a second desorption gas stream G4 that includes the gas(es), the vapor(s), or the mixture thereof desorbed from the sorbent 120. The second desorption stream G4 may pass through the damper 423 into the desorption conduit 410. The second desorption gas stream G4 may then be removed from the desorption conduit 410 via the flow outlet 413 or may be cycled back towards the desorption chamber 420.

In case of the direct heating of the sorbent 120, gases within the closed flowpath including the desorption conduit 410 and the desorption chamber 420 may be vacuumed via the flow outlet 413 to form a complete or partial vacuum within the closed flowpath. When the sorbent 120 in the sorbent cart 100 is heated, the gas(es), the vapor(s), or the mixture thereof may be released from the closed flowpath and may be removed from the closed flowpath via the flow outlet 413.

According to one or more embodiments, the desorption stations 400 may include only the desorption chamber 420 without the desorption conduit 410. The flow outlet 413 may be formed on or coupled to the desorption chamber 420. The flow inlet 411 may also be formed on or coupled to the desorption chamber 420. The heater (not shown) may also be disposed on, within, and/or coupled to the desorption conduit 410

FIG. 5 shows the track 200 being formed of a roller track 210 supported by legs 211. Alternatively or additionally, the track 200 may include a belt, a rail track, or other conveyors known in the art. The track 200 may include both active tracks that generate movement of the sorbent carts 100 on the track 200 and passive tracks that allows the sorbent carts 100 to move on the track 200 without generating the movement thereof. Alternatively, the entire track 200 may be formed of active tracks. Further, the entire track 200 may be formed of passive tracks and the dynamic adsorption and desorption system 10 may include an additional movement generating structure (not shown) that moves the sorbent carts 100 on the track 200. The desorption chamber 420 may be formed without the dampers 423, and instead the sides with the dampers 423 shown in FIG. 6 may be replaced with walls such that, when the desorption chamber doors 425 are closed, the desorption chambers 425 are isolated.

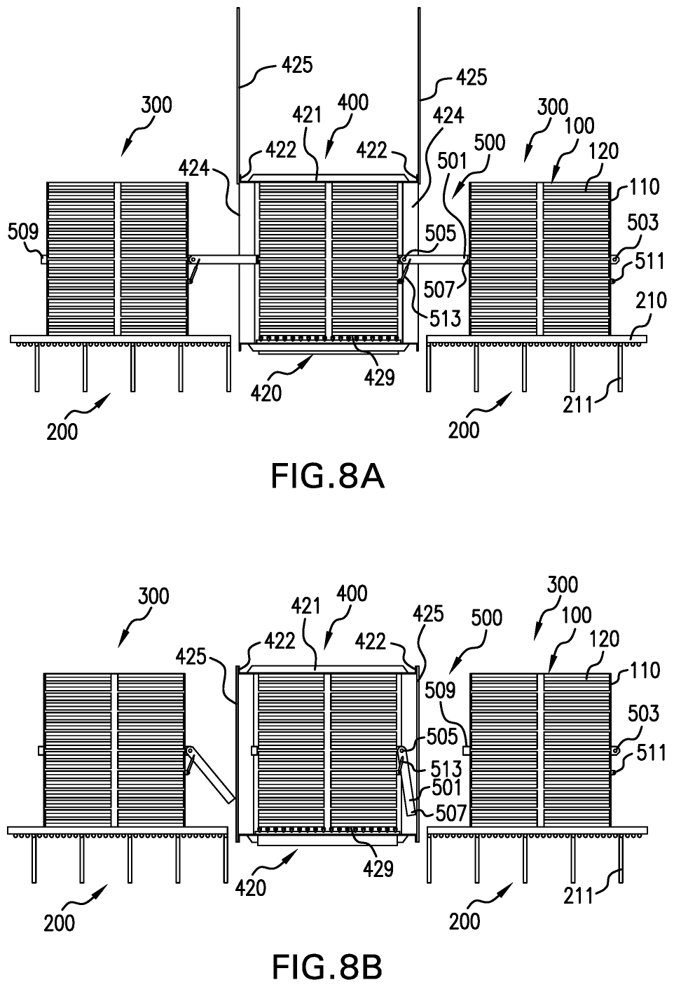

The sorbent carts 100 may be connected to each other via linkages 500. A non-limiting example of a linkage 500 is shown in FIG. 7. The linkage 500 may include a linkage arm 501 having a first end with a linkage pin hole 506 rotatably coupled to a linkage hinge 503 formed or disposed on a side surface of the sorbent cart frame 101 via a linkage pin 505. As shown in FIGS. 7, 8A, and 8B, a second end of the linkage arm 501 may include a linkage arm attachment structure 507. According to a non-limiting example, the linkage arm attachment structure 507 may be a hook structure. The linkage arm attachment structure 507 may be removably coupled to a linkage arm receiving structure 509 formed on a side surface of the sorbent cart frame 101. The linkage arm receiving structure 509 may be a loop structure in which the linkage arm attachment structure 507 is inserted when coupled and from which the linkage arm attachment structure 507 is removed when decoupled. Alternatively, the side surface of the sorbent cart frame 101 may include an attachment structure and the linkage arm 501 may include a receiving structure. Alternatively, the side surface of the sorbent cart frame 101 and the linkage arm 501 may include other coupling mechanisms known in the art. The linkage arm 501 may further include a spring hole 514. The linkage 500 may further include a compression spring 513 having a first end coupled to a spring hinge 511 and a second end coupled to the linkage arm 501 via the spring hole 514.

When the sorbent carts 100 are being moved between the adsorption stations 300 and the desorption stations 400, the linkages 500 on a trailing end surface of the sorbent cart frame 101 of one sorbent cart 100 on an active track of the track 200 or being moved by the additional movement generating structure may pull an adjacent sorbent cart 100 so that the adjacent sorbent cart 100 may be moved into and out of the desorption chamber 420 and/or move on any passive tracks of the track 200.

FIGS. 8A-8B show a process for delinking and relinking the linkages 500 when one of the sorbent carts 100 enters the desorption chamber 420. For case of explanation, the sorbent cart 100 on the left, center, and right in FIGS. 8A-8B will be referred to as first, second, and third sorbent carts 100. The desorption stations 400 may include one or more actuators (not shown) for closing and opening the desorption chamber doors 425 of the desorption chamber 420. The desorption chamber doors 425 of the desorption chamber 420 at the desorption stations 400 are initially in the open position as shown in FIGS. 5 and 8A. As the first, second, and third sorbent carts 100 are moved between the adsorption stations 300 and the desorption stations 400, the sorbent carts 100 are linked by the linkages 500 therebetween. Thus, a first sorbent cart 100 may be moved by the track 200, a preceding sorbent cart 100, and/or an external mechanism, and pull the second sorbent cart 100 into the desorption chamber 420 via the linkage 500 therebetween. The second sorbent cart 100 may move within the desorption chamber 420 via the low friction floor 420. The second sorbent cart 100 may pull the third sorbent cart 100 onto the adsorption station 300 preceding the desorption station 400, although the third card itself may be moved via the track 200 and/or an external mechanism as well. Once the second sorbent cart 100 is in the desorption chamber 420, the desorption chamber doors 425 are moved from the open position shown in FIGS. 5 and 8A to the closed position shown in FIG. 8B. As the desorption chamber doors 425 move downward from the open position to the closed position, the desorption chamber doors 425 push down on the linkage arms 501, uncoupling the linkage arm attachment structures 507 from the linkage arm receiving structures 509 and rotating the linkage arms 501 about the linkage hinge 503 while compressing the compression spring 513 until the linkage arm 501 attached to the first sorbent cart 100 is outside of the desorption chamber 420 and the linkage arm 501 attached to the second sorbent cart 100 is inside of the desorption chamber 420. The linkage arm 501 and/or the linkage arm attachment structure 507 may abut the wear pads 427 disposed on the desorption chamber doors 425 to prevent or minimize damage to the linkage arm 501, the linkage arm attachment structure 507, and/or the desorption chamber doors 425. The wear pads 427 may also allow the linkage arm 501 and/or the linkage arm attachment structure 507 to slide with respect to the desorption chamber doors 425.

Once the desorption chamber doors 425 are in the closed position shown in FIG. 8B, the desorption chamber doors 425 seal the desorption chamber 420 on two sides. Thus, the second sorbent cart 100 may be isolated within the desorption chamber 420 and/or the desorption conduit 410 such that the desorption process may be performed on the sorbent 120 within the second sorbent cart 100.

Once the desorption process is performed for a period of time and/or completed, the desorption chamber doors 425 are lifted back to the open position shown in FIGS. 5 and 8A which decompresses the compression spring 513, forcing the linkage arm 501 back up and recoupling the linkage arm attachment structures 507 and the linkage arm receiving structures 509. Thereafter, the first sorbent cart 100 may pull the second sorbent cart 100 out of the desorption chamber 420 via the linkage 500 therebetween, and the second sorbent cart 100 may pull the third sorbent cart 100 into the desorption chamber 420 via the linkage 500 therebetween. This process may be repeated continuously or for a predetermined length of time.

While a low friction floor 429 is shown within the desorption chamber 420, an active track and/or a moving mechanism may be disposed within the desorption chamber 420 to actively move the sorbent cart 100 in and out of the desorption chamber 420.

One or more embodiments of the dynamic adsorption and desorption system 10 may allow for airflow through a vacuum chamber during the desorption process, even if the sorbent cart 100 is not vacuum rated. One or more embodiments of the dynamic adsorption and desorption system 10 may allow for simultaneous, efficient adsorption and desorption of sorbent carts 100 while reducing the duplication of components. One or more embodiments of the dynamic adsorption and desorption system 10 may reduce the amount of desorption equipment required for desorption of the sorbent carts 100. One or more embodiments of the dynamic adsorption and desorption system 10 may reduce energy consumption by not requiring heating and cooling cycles for each of the adsorption stations 300 and the desorption stations 400. One or more embodiments of the dynamic adsorption and desorption system 10 may allow for axial airflow through the vacuum chamber formed by the desorption chamber 420 and the desorption conduit 410 with reduced air impedance on either side thereof. One or more embodiments of the dynamic adsorption and desorption system 10 may allow for precise locating of the movement of the sorbent carts 100 between and within the adsorption stations 300 while maintaining consistent spacing between the sorbent carts 100 via the linkages 500. One or more embodiments of the dynamic adsorption and desorption system 10 may allow drive system equipment for the track 200 to remain outside of the desorption chamber 420 without exposure to heat, wet conditions, vacuum conditions, etc.

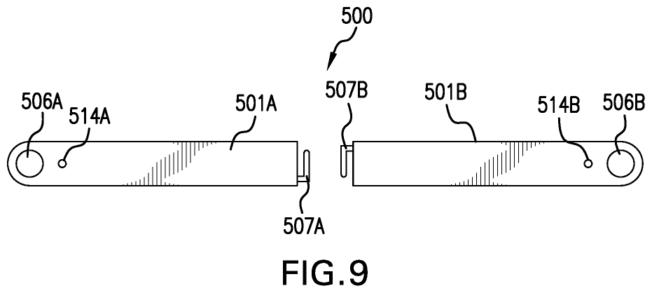

A non-limiting example of a linkage 500 is shown in FIG. 9. The linkage 500 may include a first linkage arm 501A and a second linkage arm 501B. The first linkage arm 501A may have a first end with a linkage pin hole 506A rotatably coupled to a linkage hinge 503A formed or disposed on a side surface of the sorbent cart frame 101 via a linkage pin 505A. A second end of the first linkage arm 501A may include a first linkage arm attachment structure 507A. The second linkage arm 501B may have a second end with a linkage pin hole 506B rotatably coupled to a linkage hinge 503B formed or disposed on a side surface of the sorbent cart frame 101 via a linkage pin 505B. A first end of the second linkage arm 501B may include a second linkage arm attachment structure 507B. According to a non-limiting example, the first and second linkage arm attachment structures 507A, 507B may be hook structures that are engageable with each other. The first and second linkage arm attachment structures 507A, 507B may be removably coupled to each other. One of the first and second linkage arm attachment structures 507A, 507B may be a hook structure, and the other of the first and second linkage arm attachment structures 507A, 507B may be a loop structure in which hook structure is inserted when coupled and from which the hook structure is removed when decoupled. Alternatively, first and second linkage arm attachment structures 507A, 507B may be other coupling mechanisms known in the art. The first linkage arm 501A may further include a spring hole 514A. The second linkage arm 501B may further include a spring hole 514B. The linkage 500 may further include a compression spring 513A having a first end coupled to a spring hinge 511A and a second end coupled to the first linkage arm 501A via the spring hole 514A, and a compression spring 513B having a first end coupled to a spring hinge 511B and a second end coupled to the second linkage arm 501B via the spring hole 514B.

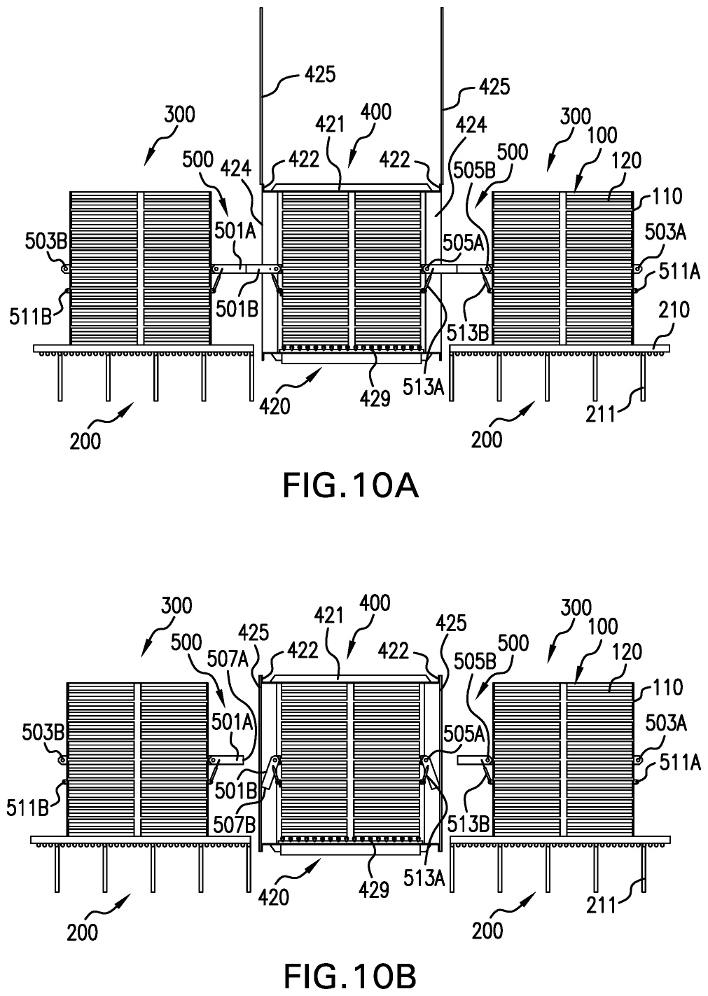

FIGS. 10A-10B show a process for delinking and relinking the linkages 500 when one of the sorbent carts 100 enters the desorption chamber 420. The process is similar to that described with respect to FIGS. 8A-8B, except that the linkage 500 of FIG. 9 is employed. The desorption chamber doors 425 of the desorption chamber 420 at the desorption stations 400 are initially in the open position as shown in FIG. 10A. Once the second sorbent cart 100 is in the desorption chamber 420, the desorption chamber doors 425 are moved from the open position shown in FIG. 10A to the closed position shown in FIG. 10B. As the desorption chamber doors 425 move downward from the open position to the closed position, the desorption chamber doors 425 push down on the linkage arms 501A, 501B. The desorption chamber door 425 on the left may push down on the second linkage arm 501B and the desorption chamber door 425 on the right may push down on the first linkage arm 501A, uncoupling the first and second linkage arm attachment structures 507A, 507B from each other and rotating the first and second linkage arms 501A, 501B about the linkage hinges 503A, 503B while compressing the compression springs 513A, 513B until the first and second linkage arms 501A, 501B attached to the second sorbent cart 100 is inside of the desorption chamber 420. While the linkages 500 shown in FIGS. 7-8B have one linkage arm so as to couple and uncouple at or near a surface of the sorbent cart 100, the linkages 500 shown in FIGS. 9-10B have two linkage arms so as to couple and decouple at or near a central portion of the linkages 500.

The wear pads 427 may be on inside surfaces of the desorption chamber doors 425, and the first second linkage arm 501A, the second linkage arm 501B, the first linkage arm attachment structure 507A, and/or the second linkage arm attachment structure 507B may abut the wear pads 427 to prevent or minimize damage. The wear pads 427 may also allow the first linkage arm 501A, the second linkage arm 501B, the first linkage arm attachment structure 507A, and/or the second linkage arm attachment structure 507B to slide with respect to the desorption chamber doors 425.

While a sorbent cart 100 that holds sorbent 120 is described above, a structure formed of sorbent 120 may be used in place of the sorbent cart 100 in the dynamic adsorption and desorption system 20.

Set forth below are some embodiments of the foregoing disclosure:

Embodiment 1: A system including a first sorbent structure and a second sorbent structure, each of the first structure and the second structure comprising sorbent, a linkage configured to couple the first sorbent structure to the second sorbent structure, a desorption chamber comprising a desorption chamber door having an open position and a closed position, wherein, when the first sorbent structure or the second sorbent structure is within the desorption chamber and the desorption chamber door moves from the open position to the closed position, the first sorbent structure is decoupled from the second sorbent structure.

Embodiment 2: The system as in any prior embodiment, wherein the first sorbent structure is coupled to the second sorbent structure when the desorption chamber door moves from the closed position to the open position.

Embodiment 3: The system as in any prior embodiment, wherein the linkage comprises a linkage arm that is pushed by the desorption chamber door when the desorption chamber door is moved from the open position to the closed position to decouple the first sorbent structure from the second sorbent structure.

Embodiment 4: The system as in any prior embodiment, wherein the linkage comprises a compression spring that is decompressed to move a linkage arm of the linkage to couple the first sorbent structure and the second sorbent structure when the desorption chamber door moves from the closed position to the open position.

Embodiment 5: The system as in any prior embodiment, wherein, when the desorption chamber door is in the closed position, an airtight seal is formed between the desorption chamber door and a flange of the desorption chamber.

Embodiment 6: The system as in any prior embodiment, wherein the desorption chamber is coupled to a desorption conduit such that, when the desorption chamber door is in the closed position, the desorption chamber and the desorption conduit form an airtight flow loop.

Embodiment 7: The system as in any prior embodiment, wherein the system is configured to heat the sorbent of the first sorbent structure or the second sorbent structure within the desorption chamber to release gas(es), vapor(s), or a mixture thereof from the sorbent.

Embodiment 8: The system as in any prior embodiment, wherein the first sorbent structure and the second sorbent structure are sorbent carts.

Embodiment 9: A system including sorbent structures comprising sorbent, linkages disposed between the sorbent structures configured to couple the sorbent structures together, a track configured to move the sorbent structures between adsorption stations in which the sorbent in the sorbent structures adsorbs gas(es), vapor(s), or a mixture thereof from a gas stream, and at least one desorption station in which desorption is performed on the sorbent in the sorbent structures, and a desorption chamber disposed at the desorption station comprising a desorption chamber door having an open position and a closed position, wherein, when a first sorbent structure of the sorbent structures is within the desorption chamber and the desorption chamber door moves from the open position to the closed position, the first sorbent structure is decoupled from a second sorbent structure of the sorbent structures that is adjacent to the first sorbent structure.

Embodiment 10: The system as in any prior embodiment, wherein the first sorbent structure and the second sorbent structure are coupled when the desorption chamber door moves from the closed position to the open position.

Embodiment 11: The system as in any prior embodiment, wherein the linkage comprises a linkage arm that is pushed by the desorption chamber door when the desorption chamber door is moved from the open position to the closed position to decouple the first sorbent structure from the second sorbent structure.

Embodiment 12: The system as in any prior embodiment, wherein the linkage comprises a compression spring that is decompressed to move a linkage arm of the linkage to couple the first sorbent structure and the second sorbent structure when the desorption chamber door moves from the closed position to the open position.

Embodiment 13: The system as in any prior embodiment, wherein, when the desorption chamber door is in the closed position, an airtight seal is formed between the desorption chamber door and a flange of the desorption chamber.

Embodiment 14: The system as in any prior embodiment, wherein the desorption chamber is coupled to a desorption conduit such that, when the desorption chamber door is in the closed position, the desorption chamber and the desorption conduit form an airtight flow loop.

Embodiment 15: The system as in any prior embodiment, wherein the system is configured to heat the sorbent of the first sorbent structure or the second sorbent structure within the desorption chamber to release gas(es), vapor(s), or a mixture thereof from the sorbent.

Embodiment 16: The system as in any prior embodiment, wherein the sorbent structures are sorbent carts.

Embodiment 17: The system as in any prior embodiment, wherein the track forms a loop, and the track is configured to move the sorbent structures between the adsorption stations and the at least one desorption station continuously in the loop.

Embodiment 18: The system as in any prior embodiment, wherein the sorbent structures are connected by the linkages so as to form a loop.

Embodiment 19: A method for desorption of a first sorbent structure coupled to a second sorbent structure via a linkage including moving a first sorbent structure into a desorption chamber with a desorption chamber door in an open position, moving the desorption chamber door to a closed position such that the first sorbent structure is decoupled from the second sorbent structure, performing desorption of sorbent of the first sorbent structure, moving the desorption chamber door to the open position such that the first sorbent structure is recoupled to the second sorbent structure, and simultaneously moving the first sorbent structure out of the desorption chamber and moving the second sorbent structure into the desorption chamber.

Embodiment 20: The method as in any prior embodiment, wherein sorbent of the second sorbent structure undergoes an adsorption process while the first sorbent structure is within the desorption chamber.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” can include a range of ±8% of a given value.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A system comprising:
a first sorbent structure and a second sorbent structure, each of the first structure and the second structure comprising sorbent;
a linkage configured to couple the first sorbent structure to the second sorbent structure;
a desorption chamber comprising a desorption chamber door having an open position and a closed position,
wherein, when the first sorbent structure or the second sorbent structure is within the desorption chamber and the desorption chamber door moves from the open position to the closed position, the first sorbent structure is decoupled from the second sorbent structure.

2. The system of claim 1, wherein the first sorbent structure is coupled to the second sorbent structure when the desorption chamber door moves from the closed position to the open position.

3. The system of claim 1, wherein the linkage comprises a linkage arm that is pushed by the desorption chamber door when the desorption chamber door is moved from the open position to the closed position to decouple the first sorbent structure from the second sorbent structure.

4. The system of claim 2, wherein the linkage comprises a compression spring that is decompressed to move a linkage arm of the linkage to couple the first sorbent structure and the second sorbent structure when the desorption chamber door moves from the closed position to the open position.

5. The system of claim 1, wherein, when the desorption chamber door is in the closed position, an airtight seal is formed between the desorption chamber door and a flange of the desorption chamber.

6. The system of claim 1, wherein the desorption chamber is coupled to a desorption conduit such that, when the desorption chamber door is in the closed position, the desorption chamber and the desorption conduit form an airtight flow loop.

7. The system of claim 1, wherein the system is configured to heat the sorbent of the first sorbent structure or the second sorbent structure within the desorption chamber to release gas(es), vapor(s), or a mixture thereof from the sorbent.

8. The system of claim 1, wherein the first sorbent structure and the second sorbent structure are sorbent carts.

9. A system comprising:
sorbent structures comprising sorbent;
linkages disposed between the sorbent structures configured to couple the sorbent structures together;
a track configured to move the sorbent structures between adsorption stations in which the sorbent in the sorbent structures adsorbs gas(es), vapor(s), or a mixture thereof from a gas stream, and at least one desorption station in which desorption is performed on the sorbent in the sorbent structures; and
a desorption chamber disposed at the desorption station comprising a desorption chamber door having an open position and a closed position;
wherein, when a first sorbent structure of the sorbent structures is within the desorption chamber and the desorption chamber door moves from the open position to the closed position, the first sorbent structure is decoupled from a second sorbent structure of the sorbent structures that is adjacent to the first sorbent structure.

10. The system of claim 9, wherein the first sorbent structure and the second sorbent structure are coupled when the desorption chamber door moves from the closed position to the open position.

11. The system of claim 9, wherein the linkage comprises a linkage arm that is pushed by the desorption chamber door when the desorption chamber door is moved from the open position to the closed position to decouple the first sorbent structure from the second sorbent structure.

12. The system of claim 10, wherein the linkage comprises a compression spring that is decompressed to move a linkage arm of the linkage to couple the first sorbent structure and the second sorbent structure when the desorption chamber door moves from the closed position to the open position.

13. The system of claim 9, wherein, when the desorption chamber door is in the closed position, an airtight seal is formed between the desorption chamber door and a flange of the desorption chamber.

14. The system of claim 9, wherein the desorption chamber is coupled to a desorption conduit such that, when the desorption chamber door is in the closed position, the desorption chamber and the desorption conduit form an airtight flow loop.

15. The system of claim 9, wherein the system is configured to heat the sorbent of the first sorbent structure or the second sorbent structure within the desorption chamber to release gas(es), vapor(s), or a mixture thereof from the sorbent.

16. The system of claim 9, wherein the sorbent structures are sorbent carts.

17. The system of claim 9, wherein the track forms a loop, and the track is configured to move the sorbent structures between the adsorption stations and the at least one desorption station continuously in the loop.

18. The system of claim 17, wherein the sorbent structures are connected by the linkages so as to form a loop.

19. A method for desorption of a first sorbent structure coupled to a second sorbent structure via a linkage comprising:
moving a first sorbent structure into a desorption chamber with a desorption chamber door in an open position;
moving the desorption chamber door to a closed position such that the first sorbent structure is decoupled from the second sorbent structure;
performing desorption of sorbent of the first sorbent structure;
moving the desorption chamber door to the open position such that the first sorbent structure is recoupled to the second sorbent structure; and
simultaneously moving the first sorbent structure out of the desorption chamber and moving the second sorbent structure into the desorption chamber.

20. The method of claim 19, wherein sorbent of the second sorbent structure undergoes an adsorption process while the first sorbent structure is within the desorption chamber.
